(19) United States
(12) Patent Application Publication
(10) Pub. No.: US 2015/0107121 A1
(43) Pub. Date: Apr. 23, 2015

(54) No grip cutter

(71) Applicant: Terry Koontz, Sturgis, SD (US)

(72) Inventor: Terry Koontz, Sturgis, SD (US)

(21) Appl. No.: 13/998,348

(22) Filed: Oct. 23, 2013

(51) Int. Cl. B26B 25/00

(52) U.S. Cl. CPC B26B 25/005
USPC 30/319

(57) ABSTRACT

A no grip rotary cutter is disclosed which may be used to cut materials such as cloth by pushing on the cutter with the palm of the hand.

### BACKGROUND OF THE INVENTION

1. Field of the Invention:

The present invention relates generally to hand tools and more specifically to a no grip rotary cutter which may be used to cut a variety of items including cloth.

2. Background Information:

Throughout history, people have struggled to find tools which may be used to cut various materials. For many years the rotary cutter has been used to cut materials such as cloth, paper, or even pizza.

The patent to Melter (U.S. Pat. No. 5,101,564; Apr. 7, 1992) discloses a rotary cutter which is very typical of the known configurations of such cutters. This patent provides a good history of patents issued in this field and notes the early Curtis patent (U.S. Pat. No. 278,103; May 22, 1883). The patent also includes a good general descriptions of these cutters “. . . an elongate handle with a circular cutting blade rotatably fastened to one end. The user grasps the handle and rolls the circular cutting blade along the object to be cut, placing downward and forward pressure on the cutting wheel.” All known prior art rotary cutters have the same basic configuration: a handle which the operator grips much like gripping a push broom handle or a pistol and a rotating cutting blade attached to the forward end of the handle which is ordinarily positioned below the longitudinal axis of the handle.

For a variety of reasons, quite often arthritis, many people have difficulty gripping an object in the manner prior art rotary cutters must be gripped. That is, wrapping your hand around a cylinder and squeezing the way a rotary cutter must be manipulated, is very difficult or even impossible for a sizable portion of the population.

The no grip rotary cutter of the instant invention solves the above problem by providing a tool which may be used for the same purpose as a conventional rotary cutter, but does not require a user to grip the tool in the same manner as a conventional rotary cutter. The no grip rotary cutter of the instant invention provides a design which allows a user to use the palm and the heel of the hand to push the cutter rather than requiring the user to grip the tool in a conventional manner. The instant invention includes a block and a rotary cutting blade in which the cutting blade is rotatably affixed to the block at the bottom surface of the block and rearward of the midpoint of the block. The instant invention provides a rotary cutter which may be pushed with the palm and heel of the hand. The device is also simple, light weight, reliable, inexpensive, and easy to operate and maintain.

### SUMMARY OF THE INVENTION

The no grip rotary cutter of the instant invention includes a block having the same general shape as a bar of soap and being of appropriate size to comfortably fit in the palm of the hand. A stud protrudes downward from the block near the middle of the block, but rearward from the center of the block. A rotary cutting blade is rotatably affixed to the stud near the center of the stud but rearward of the center of the stud. A strap is also affixed to the block. The strap is affixed such that it passes across the top of the block perpendicular to the plane of the cutting blade. A user may push a hand through the strap to hold the block. The strap acts to secure the hand to the block. The rearward end of the block fits against the heel of the hand.

In operation, a user places the cutter of the instant invention with the rotary cutting blade at the start of the cut the user intends to make and then pushing the cutter down and forward such that the cutting blade follows the line of the intended cut. The cutting blade will cut the material in the same manner as conventional rotary cutters; but the user will push the blade with the heel and palm of the hand, rather than with a cylinder gripped in the hand in the manner of a conventional rotary cutter.

One of the major objects of the present invention is to provide a rotary cutter which may be pushed with the palm and heel of the hand.

Another objective of the present invention is to provide a no grip rotary cutter which is simple, light weight, reliable, inexpensive, and easy to operate and maintain.

These and other features of the invention will become apparent when taken in consideration with the following detailed description and the drawings.

### BRIEF DESCRIPTION OF THE DRAWINGS

FIG. 1 is a front view of the preferred embodiment of the no grip rotary cutter of the instant invention; and

FIG. 2 is a side view of the instant invention.

### DESCRIPTION OF A PREFERRED EMBODIMENT

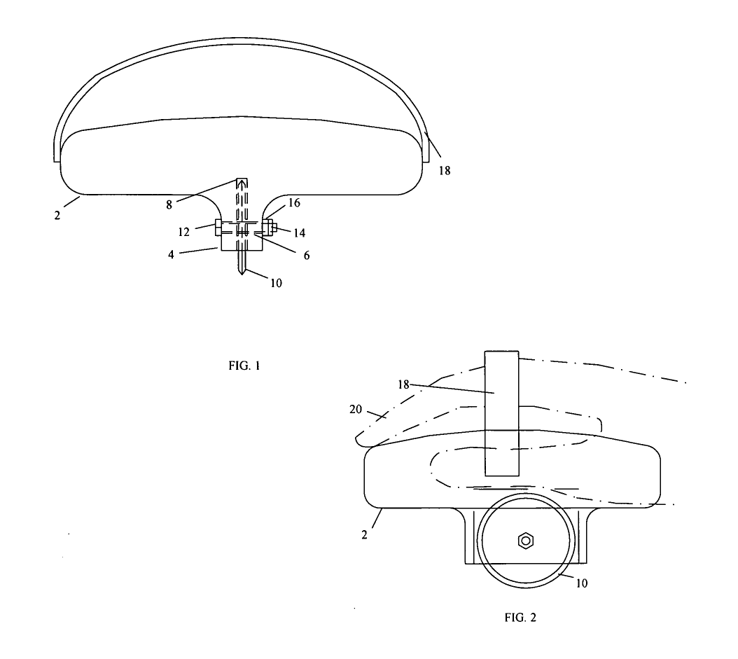

Referring to the drawings, FIGS. 1 and 2 there is shown a preferred embodiment of the instant invention. As with any conventional rotary cutter, the rotary cutter of the instant invention cut by pushing the cutter downward and forward. The direction of cutting travel is considered forward. The forward/rearward axis is considered the line of travel.

Now referring to FIG. 1, a front view of a no grip rotary cutter of the instant invention is shown. A block 2 is provided which is of appropriate size and shape to fit comfortably in the hand. A stud 4 protrudes downward from the base of the block 2. The stud 4 is longer in the direction of the line of travel than it is wide. Said stud 4 is slightly longer than the diameter of a conventional circular cutting blade. Said stud 4 is in the middle of the block 2 in the line of travel and slightly rearward of the centerline of said block 2 in a horizontal axis perpendicular to the line of travel. There is a hole 6 through said stud 4 near the center of said stud 4 and in a horizontal axis perpendicular to the line of travel. There is a slot 8 in said stud 4 which is centered through the line of travel and about the hole 6. The slot 8 is slightly longer in the direction of travel than the diameter of a conventional circular cutting blade and slightly wider than the thickness of a conventional circular cutting blade.

Still referring to FIG. 1, a conventional circular cutting blade 10 is secured within said slot 8 by centering the hole in the circular cutting blade 10 with said hole 6 and inserting a bolt 12 through said stud 4 and said circular cutting blade 10 and securing the bolt 12 with a nut 14 and a locking nut 16. The depth of said slot 4 is such that when said circular cutting blade 10 is secured by said bolt 12, a portion of said circular cutting blade 10 protrudes beyond the bottom surface of said stud 4. Said slot 8 may extend upward into said block 2. A strap 18 is affixed to the sides of said block 2 such that it passes over the top of said block 2 such that it is generally horizontal and perpendicular to the line of travel. The strap 18 is of sufficient length that a user may place the fingers between said strap 18 and the top surface of said block 2 and, by pushing the hand forward until said trap 18 engages the back of the hand and removably secures the hand to said block 2.

Referring now to FIG. 2, a side view of the instant invention is shown. This view, perhaps, better shows the alignment and relative position of the various elements. This view shows that the center of said circular cutting blade 10 is slightly rearward of the center of said block 2. This view also shows the manner in which a user's hand 20 fits within said strap 18 to secure said block 2. This view also shows that the heel of such a user's hand 20 engages the rearward top portion of said block 2. As may be seen, when said block 2 and the rest of the no grip rotary cutter of the instant invention is pushed forward to make a cut, a user controls and pushes the cutter with the palm and heel of the hand.

In the preferred embodiment all elements are conventional with structural elements such as said block 2 being made from plastic although other materials having similar properties, such as steel or wood could be used. Said block 2 and said stud 4 were molded in a single piece. Said strap 18 may be made from cloth, leather, plastic, or any material having similar characteristics. Said strap 18 may be affixed to said block 2 in any of a number of conventional ways including hot glue. In a second embodiment, said strap 18 may be adjustable using a number of conventional fastening means including a hook and loop fastener or a buckle.

I claim:

1. A no grip rotary cutter, comprising:
(1) a block having a size and shape such that it will fit comfortably in the palm of a user's hand and the block have a forward end, a rearward end, a top, and a bottom;
(2) a stud which protrudes down from the bottom of said block which is near the center of the block and slightly rearward from the midpoint of the bottom of said block and the stud having a slot through said stud which is vertical and which opens at the bottom of said stud and said stud having a horizontal hole which passes through the slot;
(3) a bolt capable of being passed through the hole in said stud and being removably secured within the hole; and
(4) a circular cutting blade capable of being secured within said slot in said stud using the bolt and which protrudes below the bottom of said stud;
Whereby, a user may use the no grip rotary cutter to cut materials by grasping said block in the palm of the hand and pushing downward and forward.

2. The no grip rotary cutter of claim 1 in which fastening means other than a bolt is used to secured the circular cutting blade to said block.

3. The no grip rotary cutter of claim 1 in which a strap is affixed to the side of said block such that the strap acts to secure a user's hand to said no grip rotary cutter.

4. The no grip rotary cutter of claim 2 in which a strap is affixed to the side of said block such that the strap acts to secure a user's hand to said no grip rotary cutter.
